(19) United States
(12) Patent Application Publication
(10) Pub. No.: US 2018/0279442 A1
(43) Pub. Date: Sep. 27, 2018

(54) LED DRIVE CIRCUIT FOR CONTROLLING A LEAKAGE CURRENT

(71) Applicant: DONGGUAN PAN AMERICAN ELECTRONICS CO., LTD., DongGuan (CN)

(72) Inventor: Jinsheng DENG, DongGuan (CN)

(73) Assignee: DONGGUAN PAN AMERICAN ELECTRONICS CO., LTD., DongGuan (CN)

(21) Appl. No.: 15/643,490

(22) Filed: Jul. 7, 2017

(30) Foreign Application Priority Data
Mar. 23, 2017 (CN) 201710178534.7

(51) Int. Cl. H05B 33/08

(52) U.S. Cl. CPC H05B 33/0887; H05B 33/0809

(57) ABSTRACT

An LED drive circuit for controlling a leakage current includes an input circuit, a rectifier circuit, a power source control module, and an LED load module, which are successively coupled. The LED drive circuit for controlling the leakage current further includes a leakage current proof control module coupled to the rectifier circuit and the power source control module.

### CROSS REFERENCE TO RELATED APPLICATION

This application claims priority to Chinese Patent Application No 201710178534.7, entitled “LED DRIVE CIRCUIT FOR CONTROLLING A LEAKAGE” filed on Mar. 23, 2017, the contents of which are expressly incorporated by reference herein in its entirety.

### FIELD OF THE INVENTION

The present disclosure relates to the field of electronic technology, and more particularly relates to an LED drive circuit for controlling a leakage current.

### BACKGROUND OF THE INVENTION

The light-emitting diode (LED) driver circuit is an important part of the LED lamp, which has a function of accessing to the alternating current (AC) power source and converts the AC to the direct current (DC), so as to provide the power source for the LED load. The LED drive circuit has two input terminals, which are coupled to a live line and a neutral line of a mains power supply, respectively. During the process of installing or maintaining the LED lamp, there will be a condition that one input terminal of the LED driver circuit is coupled to the mains power supply, the other input LED driver circuit is not connected to the mains power supply. In this case, since the two input terminals of the LED drive circuit are not completely insulated, if the input terminal being not coupled to the mains power supply is in contact with the human body, there is a possibility that the leakage current flows through the human body, thus security risks exits during the process of installing or maintaining the LED lamp.

### SUMMARY

Therefore, it is necessary to provide an LED drive circuit for controlling a leakage current.

The LED drive circuit for controlling the leakage current includes an input circuit, a rectifier circuit, a power source control module, and an LED load module, which are successively coupled. The LED drive circuit for controlling the leakage current further includes a leakage current proof control module, which is electrically connected to the rectifier circuit and the power source control module.

These and other features of the present invention will become readily apparent upon further review of the following specification and drawings.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. The accompanying drawings in the following description are only some embodiments of the present invention, and persons of ordinary skill in the art can derive other obvious variations from the accompanying drawings without creative efforts.

FIG. 1 is a block diagram of an LED drive circuit for controlling a leakage current according to an embodiment.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

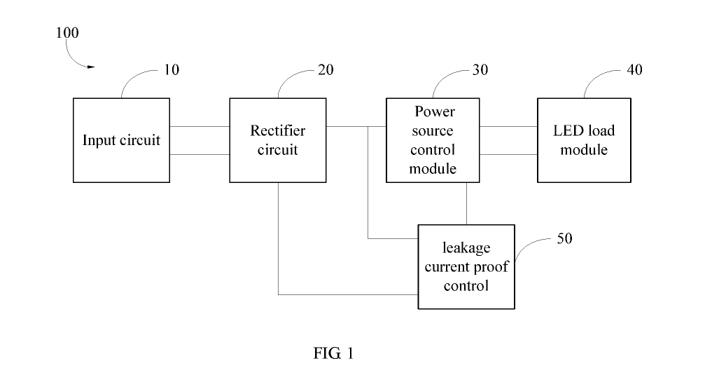

Referring to FIG. 1, the present disclosure is directed to an LED drive circuit 100 for controlling a leakage current. The LED drive circuit 100 is used to perform electric energy conversion and to generate a light source in an LED lamp which is electrically connected to the mains power supply to obtain a power source. The LED drive circuit 100 includes an input circuit 10, a rectifier circuit 20, a power source control module 30, and an LED load module 40, which are successively coupled. The LED drive circuit 100 further includes a leakage current proof control module 50, which is electrically connected to the rectifier circuit 20 and the power source control module 30.

The input circuit 10 has a plurality of input terminals; the input terminal of the input circuit 10 includes a first electric energy connection terminal and a second electric energy connection terminal, which are coupled to the mains power supply. The input circuit 10 has a plurality of output terminals; the output terminal of the input circuit 10 includes a first rectifier connection terminal and a second rectifier connection terminal, which are coupled to the rectifier circuit 20.

The input terminal of the input circuit 10 is connected to the mains power supply. The input circuit 10 can short out the the rectifier circuit 20, the power source control module 30, the LED load module 40 and the leakage current proof control module 50 and provide an overvoltage protection for them. The output terminal of the input circuit 10 provides an AC input for the rectifier circuit 20.

High impedance between the plurality of input terminals of the input circuit 10 exits. The high impedance between the plurality of output terminals of the input circuit 10 exits. The high impedance between the plurality of input terminals of the rectifier circuit exits. A low impedance path between the input terminal of the rectifier circuit does not exit, when the lamp is not connected to the mains power supply, normally. Therefore the leakage current flowing through the LED drive circuit can be controlled below a safety value, so as to ensure the safety of the human body.

The rectifier circuit 20 has a plurality of input terminals, the input terminal of the rectifier circuit 20 includes a first alternating current (AC) connection terminal and a second AC connection terminal. The first AC connection terminal and the second AC connection terminal of the rectifier circuit 20 are electrically connected to the first rectifier connection terminal and the second rectifier connection terminal of the input circuit 10, respectively. The rectifier circuit 20 has a plurality of output terminals, the output terminal of the rectifier circuit 20 includes a direct current (DC) anode and a DC cathode. The rectifier circuit 20 is used to preliminarily rectify the AC output by the input circuit 10 and generate the DC between the output terminals thereof.

The power source control module 30 is provided with a anode connection terminal, a signal receiving terminal, a positive supply terminal and a negative supply terminal. The anode connection terminal of the power source control module 30 is electrically connected to the DC anode of the rectifier circuit 20. The power source control module 30 obtains the electric energy input from the rectifier circuit 20, and provides the voltage and the power source having stable current to the LED load module 40.

The LED load module 40 is provided with a positive receiving terminal and a negative receiving terminal. The positive receiving terminal of the LED load module 40 is electrically connected to the positive supply terminal of the power source control module 30. The negative receiving terminal of the LED load module 40 is electrically connected to the negative supply terminal of the power source control module 30. The LED load module 40 is further provided with a plurality of LED modules used to generate LED light.

The leakage current proof control module has a plurality of input terminals and a plurality of control terminals. The input terminal of the leakage current proof control module 50 includes a anode access terminal and a cathode access terminal. The control terminal of the leakage current proof control module 50 includes a leakage current adjusting terminal. The anode access terminal of the leakage current proof control module 50 is electrically connected to the DC anode of the rectifier circuit 20. The cathode access terminal of the leakage current proof control module 50 is electrically connected to the DC cathode of the rectifier circuit 20. The leakage current adjusting terminal of the leakage current proof control module 50 is electrically connected to the signal receiving terminal of the power source control module 30.

The leakage current proof control module 50 can detect a voltage variation between the output terminals of the rectifier circuit 20 and adjust the operating state of the power source control module 30. when the lamp is normally connected to the mains power supply, i.e., the input terminals of the input circuit 10 are normally connected to the mains power supply, the power source control module 30 adjusts the output voltage of the rectifier circuit 20, such that the current flowing through the LED load module 40 passes is stable.

The leakage current proof control module 50 detected that the voltage between the output terminals of the circuit 20 is reduced when the lamp is not normally connected to the mains power supply, i.e. when part of input terminals of the circuit is not connected to the mains power supply. Then the leakage current proof control module 50 sends a failure signal to the power source control module 30 via the leakage current adjusting terminal thereof and the signal receiving terminal of the power source control module 30. The power source control module 30 stops the adjustment of the output voltage of the rectifier circuit 20 when the power source control module 30 receives the failure signal. Thus the current flowing through the LED load module is reduced. The impedance between the input terminals of the leakage current proof control module 50 is adjusted after the power source control module 30 stops the voltage adjustment, and high impedance between the input terminals of the leakage current proof control module 50 exits.

In the illustrated embodiment, the magnitude of the generated leakage current can be effectively limited by the leakage current proof control module capable of detecting the output voltage of the rectifier circuit is provided in the LED drive circuit for controlling the leakage current. Thus the protection can be provided to the user when installing and maintaining the lamp, so as to avoid electric shock caused by the leakage current to the user.

The foregoing implementations are merely specific embodiments of the present disclosure, but are not intended to limit the protection scope of the present disclosure. It should be noted that persons skilled in the art can understand and embody all or part of flowcharts of the above implementations. Equivalent variation figured out by persons skilled in the art shall all fall within the protection scope of the present disclosure.

1. A light-emitting diode (LED) drive circuit for controlling a leakage current, comprising an input circuit, a rectifier circuit, a power source control module, and an LED load module, which being successively coupled; wherein the LED drive circuit further comprises a leakage current proof control module coupled to the rectifier circuit and the power source control module; wherein the leakage current proof control module comprises a plurality of input terminals and a plurality of control terminals that further comprises a leakage current adjusting terminal, wherein the power source control module comprises a signal receiving terminal,
wherein, when the leakage current proof control module, via the plurality of input terminals, detects a voltage reduction, the leakage current proof control module is configured to generate, via the leakage current adjusting terminal, a failure signal to the signature receiving terminal of the power source control module; and
wherein the power source control module, upon receiving the failure signal, is configured to terminate operation of the rectifier circuit.

2. The LED drive circuit of claim 1, wherein the input circuit comprises a plurality of input terminals; the plurality of input terminals comprise a first electric energy connection terminal and a second electric energy connection terminal; the first electric energy connection terminal and the second electric energy connection terminal are coupled to a mains power supply.

3. The LED drive circuit of claim 1, wherein the input circuit comprises a plurality of output terminals; the plurality of output terminals comprise a first rectifier connection terminal and a second rectifier connection terminal; the first rectifier connection terminal and the second rectifier connection terminal are coupled to the rectifier circuit.

4. The LED drive circuit of claim 3, wherein the rectifier circuit comprises a plurality of input terminals; the plurality of input terminals comprise a first alternating current (AC) connection terminal and a second AC connection terminal; the first AC connection terminal and the second AC connection terminal are coupled to the first rectifier connection terminal and the second rectifier connection terminal, respectively.

5. The LED drive circuit of claim 4, wherein the rectifier circuit has a plurality of output terminals; the plurality of output terminals comprise a direct current (DC) anode and a DC cathode.

6. The LED drive circuit of claim 5, wherein the power source control module further comprises a anode connection terminal, a positive supply terminal, and a negative supply terminal; wherein the anode connection terminal is coupled to the DC anode; wherein the signal receiving terminal is coupled to the leakage current proof control module; wherein the positive supply terminal and the negative supply terminal are coupled to the LED load module.

7. The LED drive circuit of claim 6, wherein the LED load module comprises a positive receiving terminal and a negative receiving terminal; the positive receiving terminal is coupled to the positive supply terminal; the negative receiving terminal is coupled to the negative supply terminal.

8. The LED drive circuit of claim 6, wherein the plurality of input terminals comprise a anode access terminal and a cathode access terminal; the anode access terminal is coupled to the DC anode; the cathode access terminal is coupled to the DC cathode.
